(19) United States
(12) Patent Application Publication
(10) Pub. No.: US 2016/0026467 A1
(43) Pub. Date: Jan. 28, 2016

(54) INSTRUCTION AND LOGIC FOR EXECUTING INSTRUCTIONS OF MULTIPLE-WIDTHS

(71) Applicant: Intel Corporation, Santa Clara, CA (US)

(72) Inventors: Zeev Sperber, Zichron Yackov (IL); Robert Valentine, Kiryat Tivon (IL); Itai Ravid, Beit Itzhaq (IL); Gregory Pribush, Haifa (IL); Alex Gerber, Haifa (IL)

(21) Appl. No.: 14/340,832

(22) Filed: Jul. 25, 2014

(51) Int. Cl. G06F 9/30

(52) U.S. Cl. CPC G06F 9/30149; G06F 9/30196; G06F 9/30112

(57) ABSTRACT

A processor an execution unit, a decoder, an operation width tracker, and an allocator. The decoder includes logic to decode a received instruction. The operation width tracker includes logic to track a state indicating a currently used width of one or more registers of the processor. The allocator includes logic to selectively blend the instruction with a higher number of bits based upon a width of the instruction and the state. The execution unit may include logic to execute the selectively blended instructions.

### FIELD OF THE INVENTION

The present disclosure pertains to the field of processing logic, microprocessors, and associated instruction set architecture that, when executed by the processor or other processing logic, perform logical, mathematical, or other functional operations.

### DESCRIPTION OF RELATED ART

Multiprocessor systems are becoming more and more common. Applications of multiprocessor systems include dynamic domain partitioning all the way down to desktop computing. In order to take advantage of multiprocessor systems, code to be executed may be separated into multiple threads for execution by various processing entities. Each thread may be executed in parallel with one another.

Choosing cryptographic routines may include choosing trade-offs between security and resources necessary to implement the routine. While some cryptographic routines are not as secure as others, the resources necessary to implement them may be small enough to enable their use in a variety of applications where computing resources, such as processing power and memory, are less available than, for example, a desktop computer or larger computing scheme. The cost of implementing routines such as cryptographic routines may be measured in gate counts or gate-equivalent counts, throughput, power consumption, or production cost. Several cryptographic routines for use in computing applications include those known as AES, Hight, Iceberg, Katan, Klein, Led, mCrypton, Piccolo, Present, Prince, Twine, and EPCBC, though these routines are not necessarily compatible with each other, nor may one routine necessarily substitute for another.

### DESCRIPTION OF THE FIGURES

Embodiments are illustrated by way of example and not limitation in the Figures of the accompanying drawings:

FIG. 1A is a block diagram of an exemplary computer system formed with a processor that may include execution units to execute an instruction, in accordance with embodiments of the present disclosure;

FIG. 1B illustrates a data processing system, in accordance with embodiments of the present disclosure;

FIG. 1C illustrates other embodiments of a data processing system for performing text string comparison operations;

FIG. 2 is a block diagram of the micro-architecture for a processor that may include logic circuits to perform instructions, in accordance with embodiments of the present disclosure;

FIG. 3A is a block diagram of a processor, in accordance with embodiments of the present disclosure;

FIG. 3B is a block diagram of an example implementation of a core, in accordance with embodiments of the present disclosure;

FIG. 4 is a block diagram of a system, in accordance with embodiments of the present disclosure;

FIG. 5 is a block diagram of a second system, in accordance with embodiments of the present disclosure;

FIG. 6 is a block diagram of a third system in accordance with embodiments of the present disclosure;

FIG. 7 is a block diagram of a system-on-a-chip, in accordance with embodiments of the present disclosure;

FIG. 8 is a block diagram of an electronic device for utilizing a processor, in accordance with embodiments of the present disclosure;

FIG. 9 illustrates an example system for implementing execution of instructions of multiple widths, in accordance with embodiments of the present disclosure;

FIG. 10 is a more detailed illustration of an operation width tracker, in accordance with embodiments of the present disclosure;

FIG. 11 is a flowchart of an example embodiment of a method for implementing execution of instructions of multiple widths, in accordance with embodiments of the present disclosure.

### DETAILED DESCRIPTION

The following description describes an instruction and processing logic for implementing execution of instructions of multiple widths. Such an instructions of multiple widths may each be included in separate instruction sets in an instruction set architecture. The instruction and processing logic may be included within or in association with a processor, virtual processor, package, computer system, or other processing apparatus. In the following description, numerous specific details such as processing logic, processor types, micro-architectural conditions, events, enablement mechanisms, and the like are set forth in order to provide a more thorough understanding of embodiments of the present disclosure. It will be appreciated, however, by one skilled in the art that the embodiments may be practiced without such specific details. Additionally, some well-known structures, circuits, and the like have not been shown in detail to avoid unnecessarily obscuring embodiments of the present disclosure.

Although the following embodiments are described with reference to a processor, other embodiments are applicable to other types of integrated circuits and logic devices. Similar techniques and teachings of embodiments of the present disclosure may be applied to other types of circuits or semiconductor devices that may benefit from higher pipeline throughput and improved performance. The teachings of embodiments of the present disclosure are applicable to any processor or machine that performs data manipulations. However, the embodiments are not limited to processors or machines that perform 512-bit, 256-bit, 128-bit, 64-bit, 32-bit, or 16-bit data operations and may be applied to any processor and machine in which manipulation or management of data may be performed. In addition, the following description provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Although the below examples describe instruction handling and distribution in the context of execution units and logic circuits, other embodiments of the present disclosure may be accomplished by way of a data or instructions stored on a machine-readable, tangible medium, which when performed by a machine cause the machine to perform functions consistent with at least one embodiment of the disclosure. In one embodiment, functions associated with embodiments of the present disclosure are embodied in machine-executable instructions. The instructions may be used to cause a general-purpose or special-purpose processor that may be programmed with the instructions to perform the steps of the present disclosure. Embodiments of the present disclosure may be provided as a computer program product or software which may include a machine or computer-readable medium having stored thereon instructions which may be used to program a computer (or other electronic devices) to perform one or more operations according to embodiments of the present disclosure. Furthermore, steps of embodiments of the present disclosure might be performed by specific hardware components that contain fixed-function logic for performing the steps, or by any combination of programmed computer components and fixed-function hardware components.

Instructions used to program logic to perform embodiments of the present disclosure may be stored within a memory in the system, such as DRAM, cache, flash memory, or other storage. Furthermore, the instructions may be distributed via a network or by way of other computer-readable media. Thus a machine-readable medium may include any mechanism for storing or transmitting information in a form readable by a machine (e.g., a computer), but is not limited to, floppy diskettes, optical disks, Compact Discs, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium may include any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as may be useful in simulations, the hardware may be represented using a hardware description language or another functional description language. Additionally, a circuit level model with logic and/or transistor gates may be produced at some stages of the design process. Furthermore, designs, at some stage, may reach a level of data representing the physical placement of various devices in the hardware model. In cases wherein some semiconductor fabrication techniques are used, the data representing the hardware model may be the data specifying the presence or absence of various features on different mask layers for masks used to produce the integrated circuit. In any representation of the design, the data may be stored in any form of a machine-readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or retransmission of the electrical signal is performed, a new copy may be made. Thus, a communication provider or a network provider may store on a tangible, machine-readable medium, at least temporarily, an article, such as information encoded into a carrier wave, embodying techniques of embodiments of the present disclosure.

In modern processors, a number of different execution units may be used to process and execute a variety of code and instructions. Some instructions may be quicker to complete while others may take a number of clock cycles to complete. The faster the throughput of instructions, the better the overall performance of the processor. Thus it would be advantageous to have as many instructions execute as fast as possible. However, there may be certain instructions that have greater complexity and require more in terms of execution time and processor resources, such as floating point instructions, load/store operations, data moves, etc.

As more computer systems are used in internet, text, and multimedia applications, additional processor support has been introduced over time. In one embodiment, an instruction set may be associated with one or more computer architectures, including data types, instructions, register architecture, addressing modes, memory architecture, interrupt and exception handling, and external input and output (I/O).

In one embodiment, the instruction set architecture (ISA) may be implemented by one or more micro-architectures, which may include processor logic and circuits used to implement one or more instruction sets. Accordingly, processors with different micro-architectures may share at least a portion of a common instruction set. For example, Intel® Pentium 4 processors, Intel® Core™ processors, and processors from Advanced Micro Devices, Inc. of Sunnyvale Calif. implement nearly identical versions of the x86 instruction set (with some extensions that have been added with newer versions), but have different internal designs. Similarly, processors designed by other processor development companies, such as ARM Holdings, Ltd., MIPS, or their licensees or adopters, may share at least a portion of a common instruction set, but may include different processor designs. For example, the same register architecture of the ISA may be implemented in different ways in different micro-architectures using new or well-known techniques, including dedicated physical registers, one or more dynamically allocated physical registers using a register renaming mechanism (e.g., the use of a Register Alias Table (RAT)), a Reorder Buffer (ROB) and a retirement register file. In one embodiment, registers may include one or more registers, register architectures, register files, or other register sets that may or may not be addressable by a software programmer.

An instruction may include one or more instruction formats. In one embodiment, an instruction format may indicate various fields (number of bits, location of bits, etc.) to specify, among other things, the operation to be performed and the operands on which that operation will be performed. In a further embodiment, some instruction formats may be further defined by instruction templates (or sub-formats). For example, the instruction templates of a given instruction format may be defined to have different subsets of the instruction format's fields and/or defined to have a given field interpreted differently. In one embodiment, an instruction may be expressed using an instruction format (and, if defined, in a given one of the instruction templates of that instruction format) and specifies or indicates the operation and the operands upon which the operation will operate.

Scientific, financial, auto-vectorized general purpose, RMS (recognition, mining, and synthesis), and visual and multimedia applications (e.g., 2D/3D graphics, image processing, video compression/decompression, voice recognition algorithms and audio manipulation) may require the same operation to be performed on a large number of data items. In one embodiment, Single Instruction Multiple Data (SIMD) refers to a type of instruction that causes a processor to perform an operation on multiple data elements. SIMD technology may be used in processors that may logically divide the bits in a register into a number of fixed-sized or variable-sized data elements, each of which represents a separate value. For example, in one embodiment, the bits in a 64-bit register may be organized as a source operand containing four separate 16-bit data elements, each of which represents a separate 16-bit value. This type of data may be referred to as ‘packed’ data type or ‘vector’ data type, and operands of this data type may be referred to as packed data operands or vector operands. In one embodiment, a packed data item or vector may be a sequence of packed data elements stored within a single register, and a packed data operand or a vector operand may a source or destination operand of a SIMD instruction (or ‘packed data instruction’ or a ‘vector instruction’). In one embodiment, a SIMD instruction specifies a single vector operation to be performed on two source vector operands to generate a destination vector operand (also referred to as a result vector operand) of the same or different size, with the same or different number of data elements, and in the same or different data element order.

SIMD technology, such as that employed by the Intel® Core™ processors having an instruction set including x86, MMX™, Streaming SIMD Extensions (SSE), SSE2, SSE3, SSE4.1, and SSE4.2 instructions, ARM processors, such as the ARM Cortex® family of processors having an instruction set including the Vector Floating Point (VFP) and/or NEON instructions, and MIPS processors, such as the Loongson family of processors developed by the Institute of Computing Technology (ICT) of the Chinese Academy of Sciences, has enabled a significant improvement in application performance (Core™ and MMX™ are registered trademarks or trademarks of Intel Corporation of Santa Clara, Calif.).

In one embodiment, destination and source registers/data may be generic terms to represent the source and destination of the corresponding data or operation. In some embodiments, they may be implemented by registers, memory, or other storage areas having other names or functions than those depicted. For example, in one embodiment, “DEST1” may be a temporary storage register or other storage area, whereas “SRC1” and “SRC2” may be a first and second source storage register or other storage area, and so forth. In other embodiments, two or more of the SRC and DEST storage areas may correspond to different data storage elements within the same storage area (e.g., a SIMD register). In one embodiment, one of the source registers may also act as a destination register by, for example, writing back the result of an operation performed on the first and second source data to one of the two source registers serving as a destination registers.

FIGURE lA is a block diagram of an exemplary computer system formed with a processor that may include execution units to execute an instruction, in accordance with embodiments of the present disclosure. System 100 may include a component, such as a processor 102 to employ execution units including logic to perform algorithms for process data, in accordance with the present disclosure, such as in the embodiment described herein. System 100 may be representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 100 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present disclosure are not limited to any specific combination of hardware circuitry and software.

Embodiments are not limited to computer systems. Embodiments of the present disclosure may be used in other devices such as handheld devices and embedded applications. Some examples of handheld devices include cellular phones, Internet Protocol devices, digital cameras, personal digital assistants (PDAs), and handheld PCs. Embedded applications may include a micro controller, a digital signal processor (DSP), system on a chip, network computers (NetPC), set-top boxes, network hubs, wide area network (WAN) switches, or any other system that may perform one or more instructions in accordance with at least one embodiment.

Computer system 100 may include a processor 102 that may include one or more execution units 108 to perform an algorithm to perform at least one instruction in accordance with one embodiment of the present disclosure. One embodiment may be described in the context of a single processor desktop or server system, but other embodiments may be included in a multiprocessor system. System 100 may be an example of a ‘hub’ system architecture. System 100 may include a processor 102 for processing data signals. Processor 102 may include a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In one embodiment, processor 102 may be coupled to a processor bus 110 that may transmit data signals between processor 102 and other components in system 100. The elements of system 100 may perform conventional functions that are well known to those familiar with the art.

In one embodiment, processor 102 may include a Level 1 (L1) internal cache memory 104. Depending on the architecture, the processor 102 may have a single internal cache or multiple levels of internal cache. In another embodiment, the cache memory may reside external to processor 102. Other embodiments may also include a combination of both internal and external caches depending on the particular implementation and needs. Register file 106 may store different types of data in various registers including integer registers, floating point registers, status registers, and instruction pointer register.

Execution unit 108, including logic to perform integer and floating point operations, also resides in processor 102. Processor 102 may also include a microcode (ucode) ROM that stores microcode for certain macroinstructions. In one embodiment, execution unit 108 may include logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications may be accelerated and executed more efficiently by using the full width of a processor's data bus for performing operations on packed data. This may eliminate the need to transfer smaller units of data across the processor's data bus to perform one or more operations one data element at a time.

Embodiments of an execution unit 108 may also be used in micro controllers, embedded processors, graphics devices, DSPs, and other types of logic circuits. System 100 may include a memory 120. Memory 120 may be implemented as a Dynamic Random Access Memory (DRAM) device, a Static Random Access Memory (SRAM) device, flash memory device, or other memory device. Memory 120 may store instructions and/or data represented by data signals that may be executed by processor 102.

A system logic chip 116 may be coupled to processor bus 110 and memory 120. System logic chip 116 may include a memory controller hub (MCH). Processor 102 may communicate with MCH 116 via a processor bus 110. MCH 116 may provide a high bandwidth memory path 118 to memory 120 for instruction and data storage and for storage of graphics commands, data and textures. MCH 116 may direct data signals between processor 102, memory 120, and other components in system 100 and to bridge the data signals between processor bus 110, memory 120, and system I/O 122. In some embodiments, the system logic chip 116 may provide a graphics port for coupling to a graphics controller 112. MCH 116 may be coupled to memory 120 through a memory interface 118. Graphics card 112 may be coupled to MCH 116 through an Accelerated Graphics Port (AGP) interconnect 114.

System 100 may use a proprietary hub interface bus 122 to couple MCH 116 to I/O controller hub (ICH) 130. In one embodiment, ICH 130 may provide direct connections to some I/O devices via a local I/O bus. The local I/O bus may include a high-speed I/O bus for connecting peripherals to memory 120, chipset, and processor 102. Examples may include the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. Data storage device 124 may comprise a hard disk drive, a floppy disk drive, a CD-ROM device, a flash memory device, or other mass storage device.

For another embodiment of a system, an instruction in accordance with one embodiment may be used with a system on a chip. One embodiment of a system on a chip comprises of a processor and a memory. The memory for one such system may include a flash memory. The flash memory may be located on the same die as the processor and other system components. Additionally, other logic blocks such as a memory controller or graphics controller may also be located on a system on a chip.

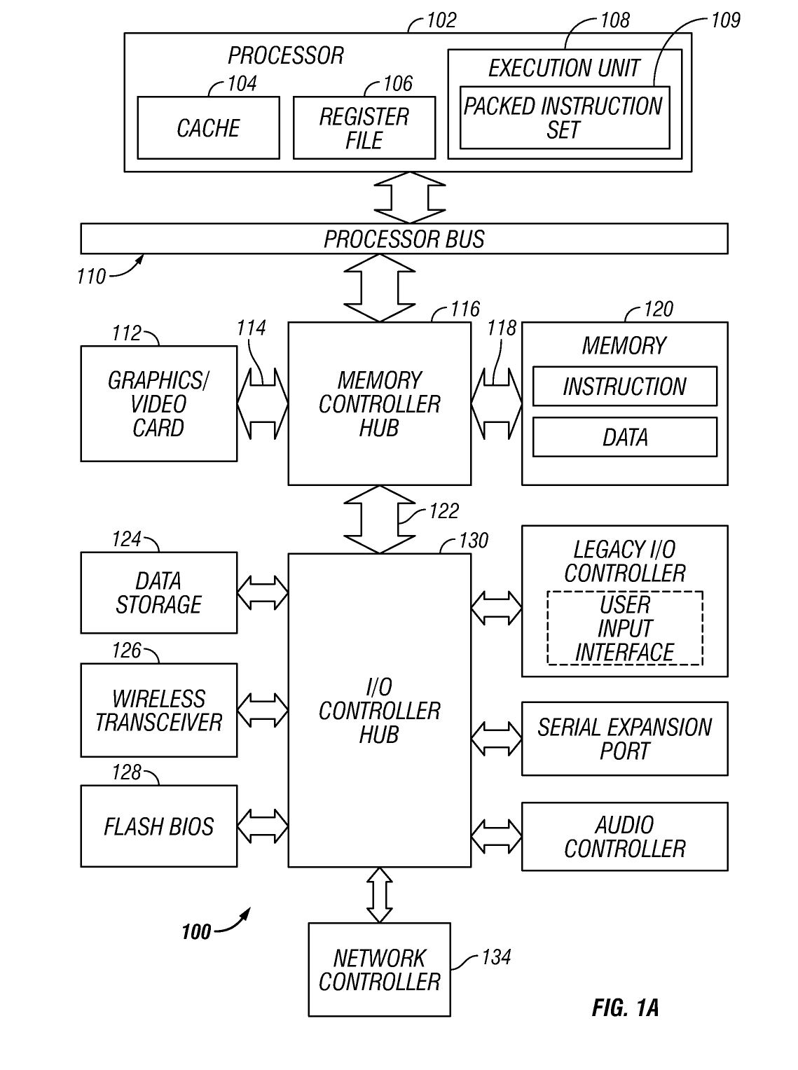

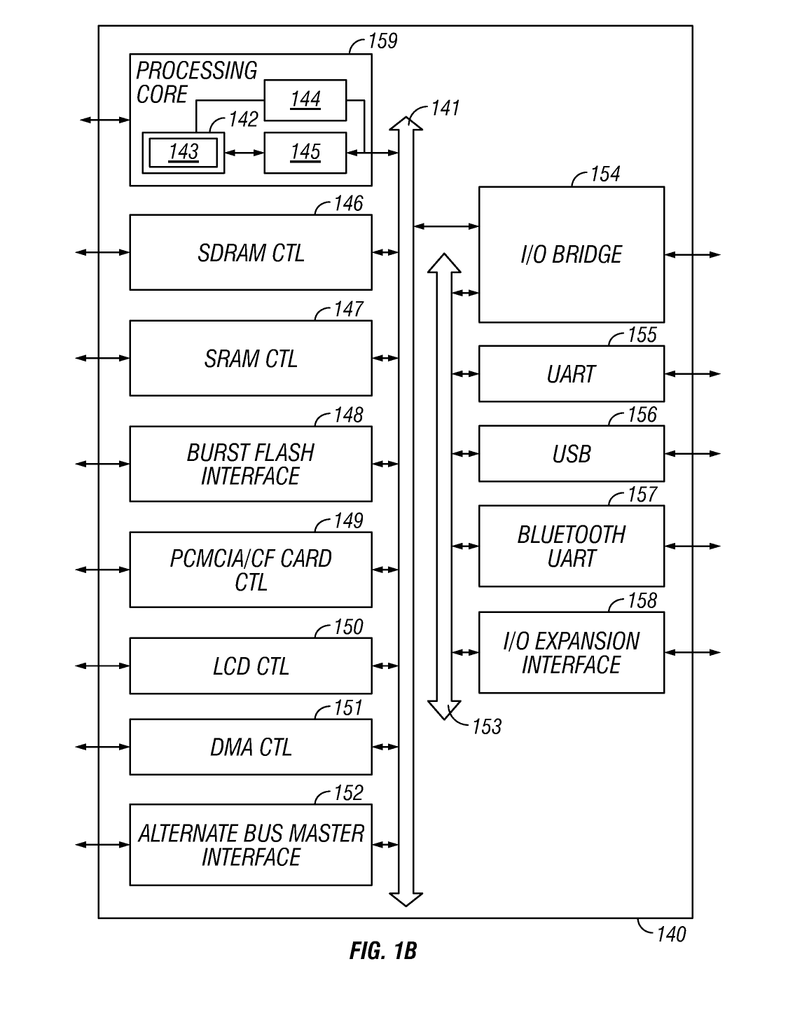

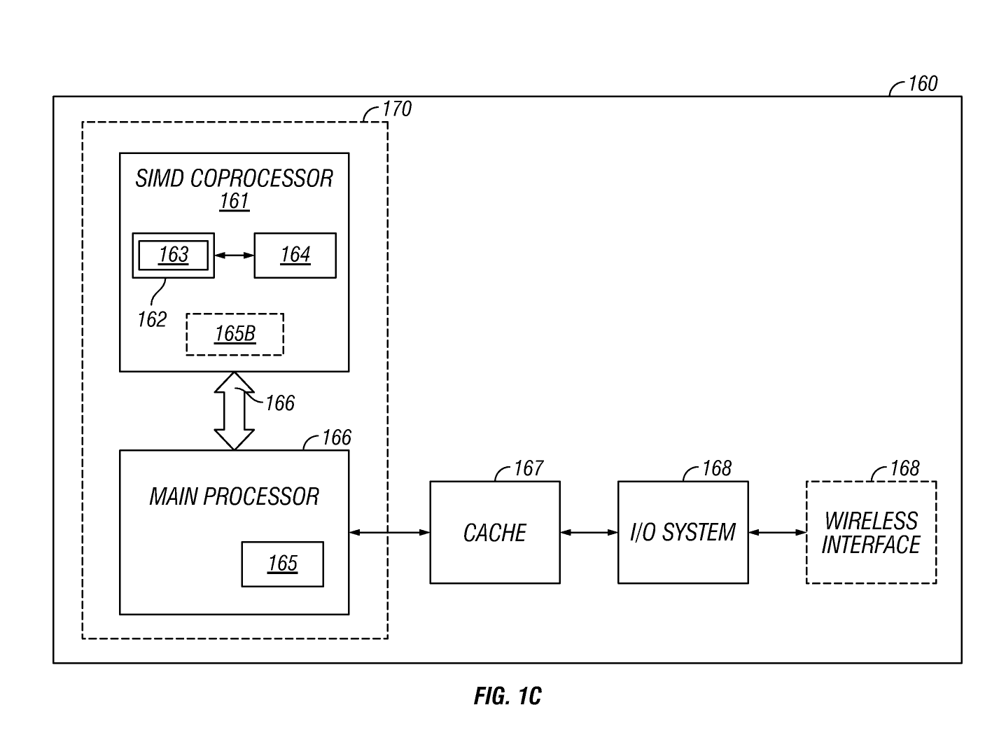

FIG. 1B illustrates a data processing system 140 which implements the principles of embodiments of the present disclosure. It will be readily appreciated by one of skill in the art that the embodiments described herein may operate with alternative processing systems without departure from the scope of embodiments of the disclosure.

Computer system 140 comprises a processing core 159 for performing at least one instruction in accordance with one embodiment. In one embodiment, processing core 159 represents a processing unit of any type of architecture, including but not limited to a CISC, a RISC or a VLIW-type architecture. Processing core 159 may also be suitable for manufacture in one or more process technologies and by being represented on a machine-readable media in sufficient detail, may be suitable to facilitate said manufacture.

Processing core 159 comprises an execution unit 142, a set of register files 145, and a decoder 144. Processing core 159 may also include additional circuitry (not shown) which may be unnecessary to the understanding of embodiments of the present disclosure. Execution unit 142 may execute instructions received by processing core 159. In addition to performing typical processor instructions, execution unit 142 may perform instructions in packed instruction set 143 for performing operations on packed data formats. Packed instruction set 143 may include instructions for performing embodiments of the disclosure and other packed instructions. Execution unit 142 may be coupled to register file 145 by an internal bus. Register file 145 may represent a storage area on processing core 159 for storing information, including data. As previously mentioned, it is understood that the storage area may store the packed data might not be critical. Execution unit 142 may be coupled to decoder 144. Decoder 144 may decode instructions received by processing core 159 into control signals and/or microcode entry points. In response to these control signals and/or microcode entry points, execution unit 142 performs the appropriate operations. In one embodiment, the decoder may interpret the opcode of the instruction, which will indicate what operation should be performed on the corresponding data indicated within the instruction.

Processing core 159 may be coupled with bus 141 for communicating with various other system devices, which may include but are not limited to, for example, Synchronous Dynamic Random Access Memory (SDRAM) control 146, Static Random Access Memory (SRAM) control 147, burst flash memory interface 148, Personal Computer Memory Card International Association (PCMCIA)/Compact Flash (CF) card control 149, Liquid Crystal Display (LCD) control 150, Direct Memory Access (DMA) controller 151, and alternative bus master interface 152. In one embodiment, data processing system 140 may also comprise an I/O bridge 154 for communicating with various I/O devices via an I/O bus 153. Such I/O devices may include but are not limited to, for example, Universal Asynchronous Receiver/Transmitter (UART) 155, Universal Serial Bus (USB) 156, Bluetooth wireless UART 157 and I/O expansion interface 158.

One embodiment of data processing system 140 provides for mobile, network and/or wireless communications and a processing core 159 that may perform SIMD operations including a text string comparison operation. Processing core 159 may be programmed with various audio, video, imaging and communications algorithms including discrete transformations such as a Walsh-Hadamard transform, a fast Fourier transform (FFT), a discrete cosine transform (DCT), and their respective inverse transforms; compression/decompression techniques such as color space transformation, video encode motion estimation or video decode motion compensation; and modulation/demodulation (MODEM) functions such as pulse coded modulation (PCM).

FIG. 1C illustrates other embodiments of a data processing system that performs SIMD text string comparison operations. In one embodiment, data processing system 160 may include a main processor 166, a SIMD coprocessor 161, a cache memory 167, and an input/output system 168. Input/output system 168 may optionally be coupled to a wireless interface 169. SIMD coprocessor 161 may perform operations including instructions in accordance with one embodiment. In one embodiment, processing core 170 may be suitable for manufacture in one or more process technologies and by being represented on a machine-readable media in sufficient detail, may be suitable to facilitate the manufacture of all or part of data processing system 160 including processing core 170.

In one embodiment, SIMD coprocessor 161 comprises an execution unit 162 and a set of register files 164. One embodiment of main processor 165 comprises a decoder 165 to recognize instructions of instruction set 163 including instructions in accordance with one embodiment for execution by execution unit 162. In other embodiments, SIMD coprocessor 161 also comprises at least part of decoder 165 to decode instructions of instruction set 163. Processing core 170 may also include additional circuitry (not shown) which may be unnecessary to the understanding of embodiments of the present disclosure.

In operation, main processor 166 executes a stream of data processing instructions that control data processing operations of a general type including interactions with cache memory 167, and input/output system 168. Embedded within the stream of data processing instructions may be SIMD coprocessor instructions. Decoder 165 of main processor 166 recognizes these SIMD coprocessor instructions as being of a type that should be executed by an attached SIMD coprocessor 161. Accordingly, main processor 166 issues these SIMD coprocessor instructions (or control signals representing SIMD coprocessor instructions) on the coprocessor bus 166. From coprocessor bus 166, these instructions may be received by any attached SIMD coprocessors. In this case, SIMD coprocessor 161 may accept and execute any received SIMD coprocessor instructions intended for it.

Data may be received via wireless interface 169 for processing by the SIMD coprocessor instructions. For one example, voice communication may be received in the form of a digital signal, which may be processed by the SIMD coprocessor instructions to regenerate digital audio samples representative of the voice communications. For another example, compressed audio and/or video may be received in the form of a digital bit stream, which may be processed by the SIMD coprocessor instructions to regenerate digital audio samples and/or motion video frames. In one embodiment of processing core 170, main processor 166, and a SIMD coprocessor 161 may be integrated into a single processing core 170 comprising an execution unit 162, a set of register files 164, and a decoder 165 to recognize instructions of instruction set 163 including instructions in accordance with one embodiment.

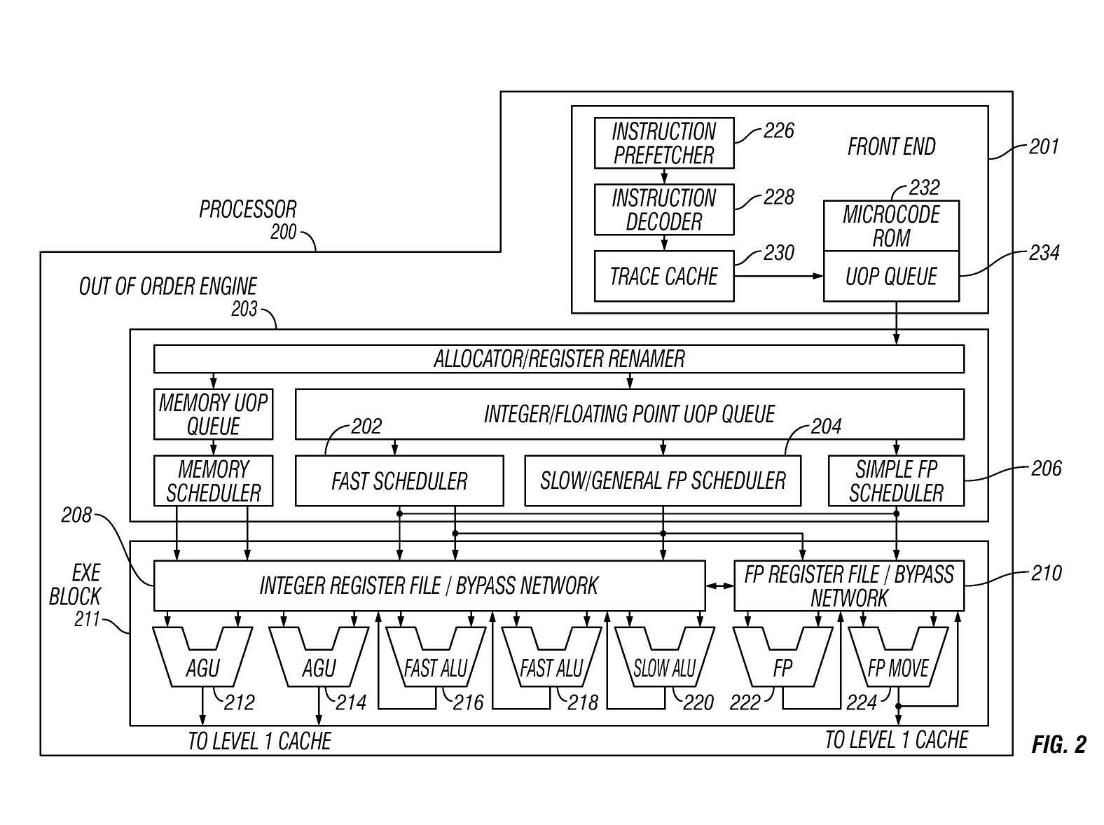

FIG. 2 is a block diagram of the micro-architecture for a processor 200 that may include logic circuits to perform instructions, in accordance with embodiments of the present disclosure. In some embodiments, an instruction in accordance with one embodiment may be implemented to operate on data elements having sizes of byte, word, doubleword, quadword, etc., as well as datatypes, such as single and double precision integer and floating point datatypes. In one embodiment, in-order front end 201 may implement a part of processor 200 that may fetch instructions to be executed and prepares the instructions to be used later in the processor pipeline. Front end 201 may include several units. In one embodiment, instruction prefetcher 226 fetches instructions from memory and feeds the instructions to an instruction decoder 228 which in turn decodes or interprets the instructions. For example, in one embodiment, the decoder decodes a received instruction into one or more operations called “micro-instructions” or “micro-operations” (also called micro op or uops) that the machine may execute. In other embodiments, the decoder parses the instruction into an opcode and corresponding data and control fields that may be used by the micro-architecture to perform operations in accordance with one embodiment. In one embodiment, trace cache 230 may assemble decoded uops into program ordered sequences or traces in uop queue 234 for execution. When trace cache 230 encounters a complex instruction, microcode ROM 232 provides the uops needed to complete the operation.

Some instructions may be converted into a single micro-op, whereas others need several micro-ops to complete the full operation. In one embodiment, if more than four micro-ops are needed to complete an instruction, decoder 228 may access microcode ROM 232 to perform the instruction. In one embodiment, an instruction may be decoded into a small number of micro-ops for processing at instruction decoder 228. In another embodiment, an instruction may be stored within microcode ROM 232 should a number of micro-ops be needed to accomplish the operation. Trace cache 230 refers to an entry point programmable logic array (PLA) to determine a correct micro-instruction pointer for reading the micro-code sequences to complete one or more instructions in accordance with one embodiment from micro-code ROM 232. After microcode ROM 232 finishes sequencing micro-ops for an instruction, front end 201 of the machine may resume fetching micro-ops from trace cache 230.

Out-of-order execution engine 203 may prepare instructions for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 202, slow/general floating point scheduler 204, and simple floating point scheduler 206. Uop schedulers 202, 204, 206, determine when a uop is ready to execute based on the readiness of their dependent input register operand sources and the availability of the execution resources the uops need to complete their operation. Fast scheduler 202 of one embodiment may schedule on each half of the main clock cycle while the other schedulers may only schedule once per main processor clock cycle. The schedulers arbitrate for the dispatch ports to schedule uops for execution.

Register files 208, 210 may be arranged between schedulers 202, 204, 206, and execution units 212, 214, 216, 218, 220, 222, 224 in execution block 211. Each of register files 208, 210 perform integer and floating point operations, respectively. Each register file 208, 210, may include a bypass network that may bypass or forward just completed results that have not yet been written into the register file to new dependent uops. Integer register file 208 and floating point register file 210 may communicate data with the other. In one embodiment, integer register file 208 may be split into two separate register files, one register file for low-order thirty-two bits of data and a second register file for high order thirty-two bits of data. Floating point register file 210 may include 128-bit wide entries because floating point instructions typically have operands from 64 to 128 bits in width.

Execution block 211 may contain execution units 212, 214, 216, 218, 220, 222, 224. Execution units 212, 214, 216, 218, 220, 222, 224 may execute the instructions. Execution block 211 may include register files 208, 210 that store the integer and floating point data operand values that the micro-instructions need to execute. In one embodiment, processor 200 may comprise a number of execution units: address generation unit (AGU) 212, AGU 214, fast Arithmetic Logic Unit (ALU) 216, fast ALU 218, slow ALU 220, floating point ALU 222, floating point move unit 224. In another embodiment, floating point execution blocks 222, 224, may execute floating point, MMX, SIMD, and SSE, or other operations. In yet another embodiment, floating point ALU 222 may include a 64-bit by 64-bit floating point divider to execute divide, square root, and remainder micro-ops. In various embodiments, instructions involving a floating point value may be handled with the floating point hardware. In one embodiment, ALU operations may be passed to high-speed ALU execution units 216, 218. High-speed ALUs 216, 218 may execute fast operations with an effective latency of half a clock cycle. In one embodiment, most complex integer operations go to slow ALU 220 as slow ALU 220 may include integer execution hardware for long-latency type of operations, such as a multiplier, shifts, flag logic, and branch processing. Memory load/store operations may be executed by AGUs 212, 214. In one embodiment, integer ALUs 216, 218, 220 may perform integer operations on 64-bit data operands. In other embodiments, ALUs 216, 218, 220 may be implemented to support a variety of data bit sizes including sixteen, thirty-two, 128, 256, etc. Similarly, floating point units 222, 224 may be implemented to support a range of operands having bits of various widths. In one embodiment, floating point units 222, 224, may operate on 128-bit wide packed data operands in conjunction with SIMD and multimedia instructions.

In one embodiment, uops schedulers 202, 204, 206, dispatch dependent operations before the parent load has finished executing. As uops may be speculatively scheduled and executed in processor 200, processor 200 may also include logic to handle memory misses. If a data load misses in the data cache, there may be dependent operations in flight in the pipeline that have left the scheduler with temporarily incorrect data. A replay mechanism tracks and re-executes instructions that use incorrect data. Only the dependent operations might need to be replayed and the independent ones may be allowed to complete. The schedulers and replay mechanism of one embodiment of a processor may also be designed to catch instruction sequences for text string comparison operations.

The term “registers” may refer to the on-board processor storage locations that may be used as part of instructions to identify operands. In other words, registers may be those that may be usable from the outside of the processor (from a programmer's perspective). However, in some embodiments registers might not be limited to a particular type of circuit. Rather, a register may store data, provide data, and perform the functions described herein. The registers described herein may be implemented by circuitry within a processor using any number of different techniques, such as dedicated physical registers, dynamically allocated physical registers using register renaming, combinations of dedicated and dynamically allocated physical registers, etc. In one embodiment, integer registers store 32-bit integer data. A register file of one embodiment also contains eight multimedia SIMD registers for packed data. For the discussions below, the registers may be understood to be data registers designed to hold packed data, such as 64-bit wide MMX™ registers (also referred to as ‘mm’ registers in some instances) in microprocessors enabled with MMX technology from Intel Corporation of Santa Clara, Calif. These MMX registers, available in both integer and floating point forms, may operate with packed data elements that accompany SIMD and SSE instructions. Similarly, 128-bit wide XMM registers relating to SSE2, SSE3, SSE4, or beyond (referred to generically as “SSEx”) technology may hold such packed data operands. In one embodiment, in storing packed data and integer data, the registers do not need to differentiate between the two data types. In one embodiment, integer and floating point may be contained in the same register file or different register files. Furthermore, in one embodiment, floating point and integer data may be stored in different registers or the same registers.

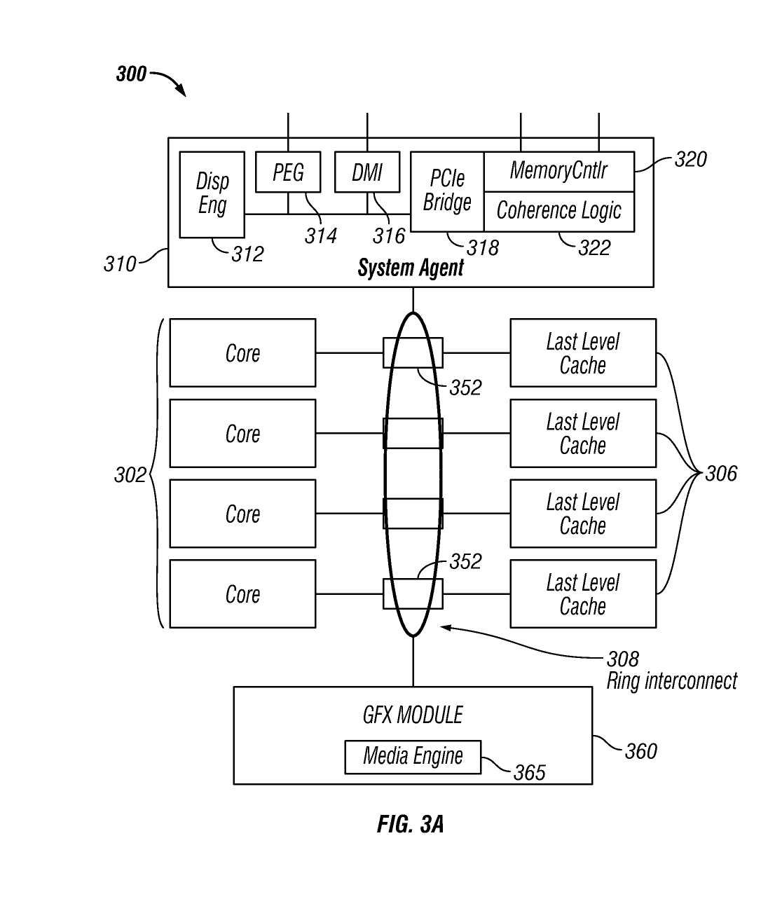

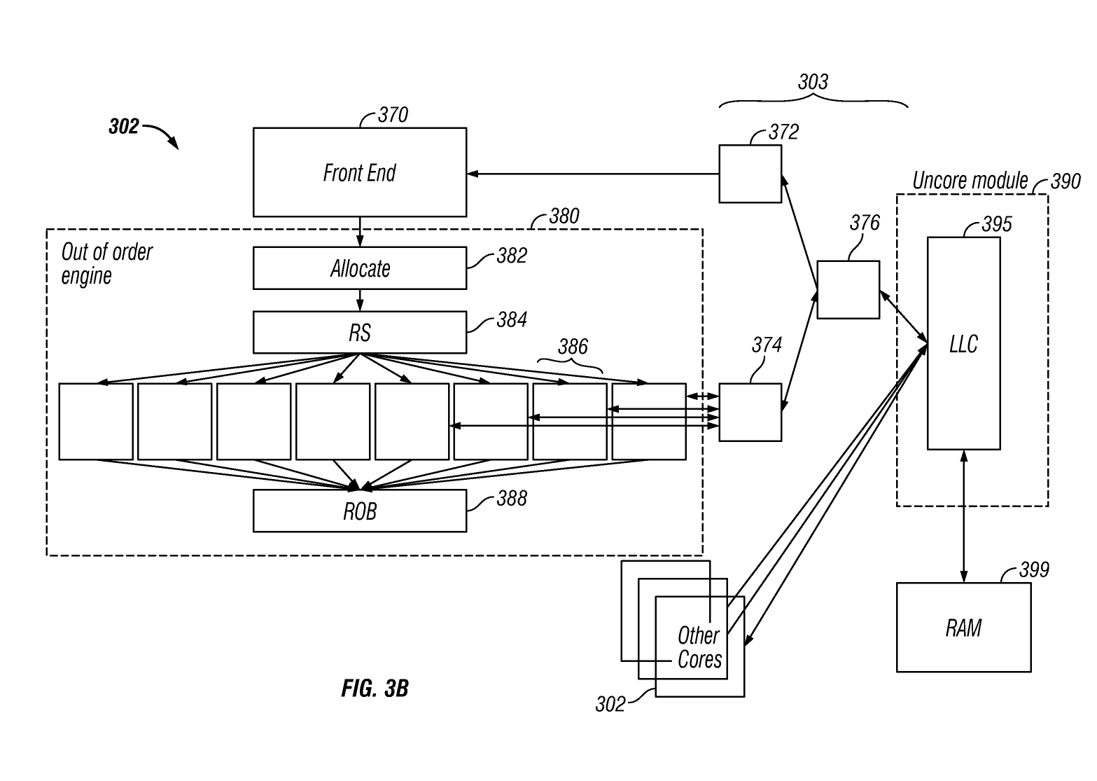

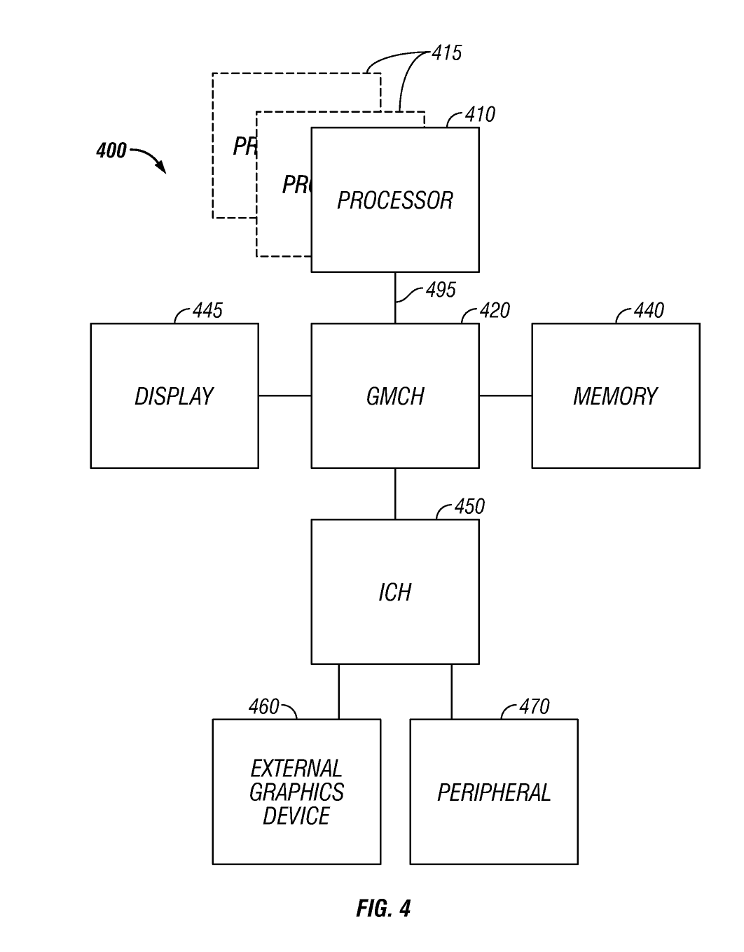

FIGS. 3-5 may illustrate exemplary systems suitable for including processor 300, while FIG. 4 may illustrate an exemplary System on a Chip (SoC) that may include one or more of cores 302. Other system designs and implementations known in the arts for laptops, desktops, handheld PCs, personal digital assistants, engineering workstations, servers, network devices, network hubs, switches, embedded processors, DSPs, graphics devices, video game devices, set-top boxes, micro controllers, cell phones, portable media players, hand held devices, and various other electronic devices, may also be suitable. In general, a huge variety of systems or electronic devices that incorporate a processor and/or other execution logic as disclosed herein may be generally suitable.

FIG. 4 illustrates a block diagram of a system 400, in accordance with embodiments of the present disclosure. System 400 may include one or more processors 410, 415, which may be coupled to Graphics Memory Controller Hub (GMCH) 420. The optional nature of additional processors 415 is denoted in FIG. 4 with broken lines.

Each processor 410, 415 may be some version of processor 300. However, it should be noted that integrated graphics logic and integrated memory control units might not exist in processors 410, 415. FIG. 4 illustrates that GMCH 420 may be coupled to a memory 440 that may be, for example, a dynamic random access memory (DRAM). The DRAM may, for at least one embodiment, be associated with a non-volatile cache.

GMCH 420 may be a chipset, or a portion of a chipset. GMCH 420 may communicate with processors 410, 415 and control interaction between processors 410, 415 and memory 440. GMCH 420 may also act as an accelerated bus interface between the processors 410, 415 and other elements of system 400. In one embodiment, GMCH 420 communicates with processors 410, 415 via a multi-drop bus, such as a frontside bus (FSB) 495.

Furthermore, GMCH 420 may be coupled to a display 445 (such as a flat panel display). In one embodiment, GMCH 420 may include an integrated graphics accelerator. GMCH 420 may be further coupled to an input/output (I/O) controller hub (ICH) 450, which may be used to couple various peripheral devices to system 400. External graphics device 460 may include be a discrete graphics device coupled to ICH 450 along with another peripheral device 470.

In other embodiments, additional or different processors may also be present in system 400. For example, additional processors 410, 415 may include additional processors that may be the same as processor 410, additional processors that may be heterogeneous or asymmetric to processor 410, accelerators (such as, e.g., graphics accelerators or digital signal processing (DSP) units), field programmable gate arrays, or any other processor. There may be a variety of differences between the physical resources 410, 415 in terms of a spectrum of metrics of merit including architectural, micro-architectural, thermal, power consumption characteristics, and the like. These differences may effectively manifest themselves as asymmetry and heterogeneity amongst processors 410, 415. For at least one embodiment, various processors 410, 415 may reside in the same die package.

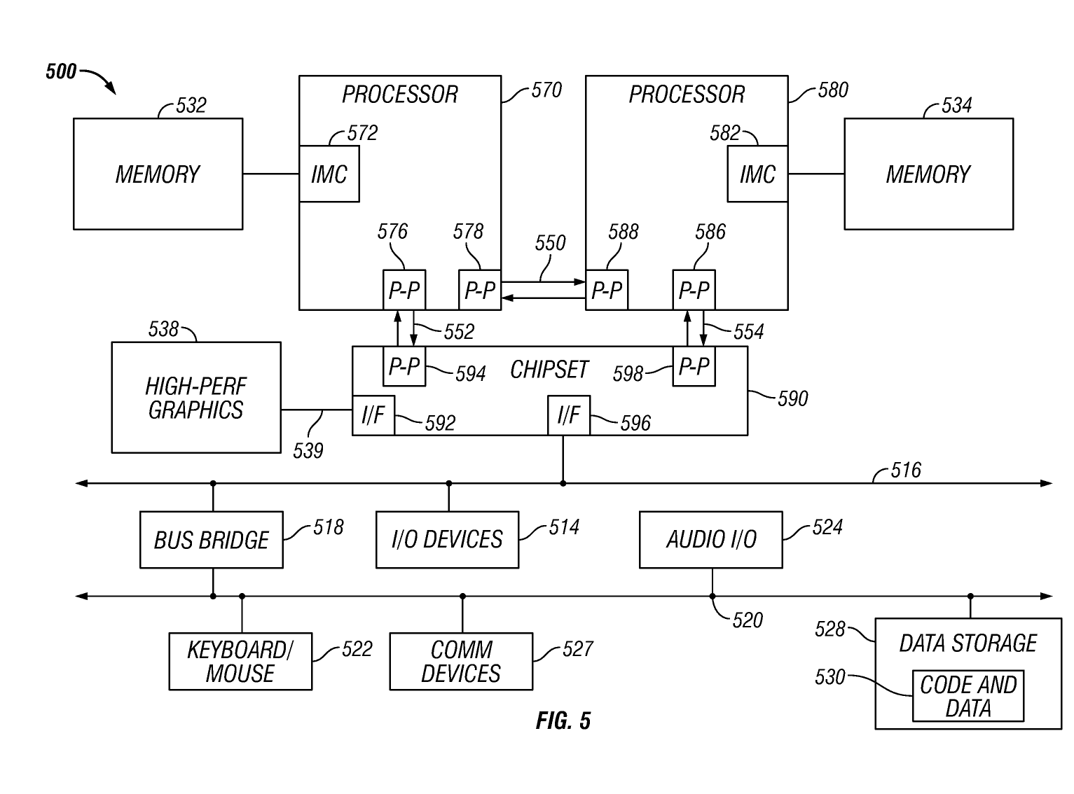

FIG. 5 illustrates a block diagram of a second system 500, in accordance with embodiments of the present disclosure. As shown in FIG. 5, multiprocessor system 500 may include a point-to-point interconnect system, and may include a first processor 570 and a second processor 580 coupled via a point-to-point interconnect 550. Each of processors 570 and 580 may be some version of processor 300 as one or more of processors 410,615.

While FIG. 5 may illustrate two processors 570, 580, it is to be understood that the scope of the present disclosure is not so limited. In other embodiments, one or more additional processors may be present in a given processor.

Processors 570 and 580 are shown including integrated memory controller units 572 and 582, respectively. Processor 570 may also include as part of its bus controller units point-to-point (P-P) interfaces 576 and 578; similarly, second processor 580 may include P-P interfaces 586 and 588. Processors 570, 580 may exchange information via a point-to-point (P-P) interface 550 using P-P interface circuits 578, 588. As shown in FIG. 5, IMCs 572 and 582 may couple the processors to respective memories, namely a memory 532 and a memory 534, which in one embodiment may be portions of main memory locally attached to the respective processors.

Processors 570, 580 may each exchange information with a chipset 590 via individual P-P interfaces 552, 554 using point to point interface circuits 576, 594, 586, 598. In one embodiment, chipset 590 may also exchange information with a high-performance graphics circuit 538 via a high-performance graphics interface 539.

A shared cache (not shown) may be included in either processor or outside of both processors, yet connected with the processors via P-P interconnect, such that either or both processors' local cache information may be stored in the shared cache if a processor is placed into a low power mode.

Chipset 590 may be coupled to a first bus 516 via an interface 596. In one embodiment, first bus 516 may be a Peripheral Component Interconnect (PCI) bus, or a bus such as a PCI Express bus or another third generation I/O interconnect bus, although the scope of the present disclosure is not so limited.

As shown in FIG. 5, various I/O devices 514 may be coupled to first bus 516, along with a bus bridge 518 which couples first bus 516 to a second bus 520. In one embodiment, second bus 520 may be a Low Pin Count (LPC) bus. Various devices may be coupled to second bus 520 including, for example, a keyboard and/or mouse 522, communication devices 527 and a storage unit 528 such as a disk drive or other mass storage device which may include instructions/code and data 530, in one embodiment. Further, an audio I/O 524 may be coupled to second bus 520. Note that other architectures may be possible. For example, instead of the point-to-point architecture of FIG. 5, a system may implement a multi-drop bus or other such architecture.

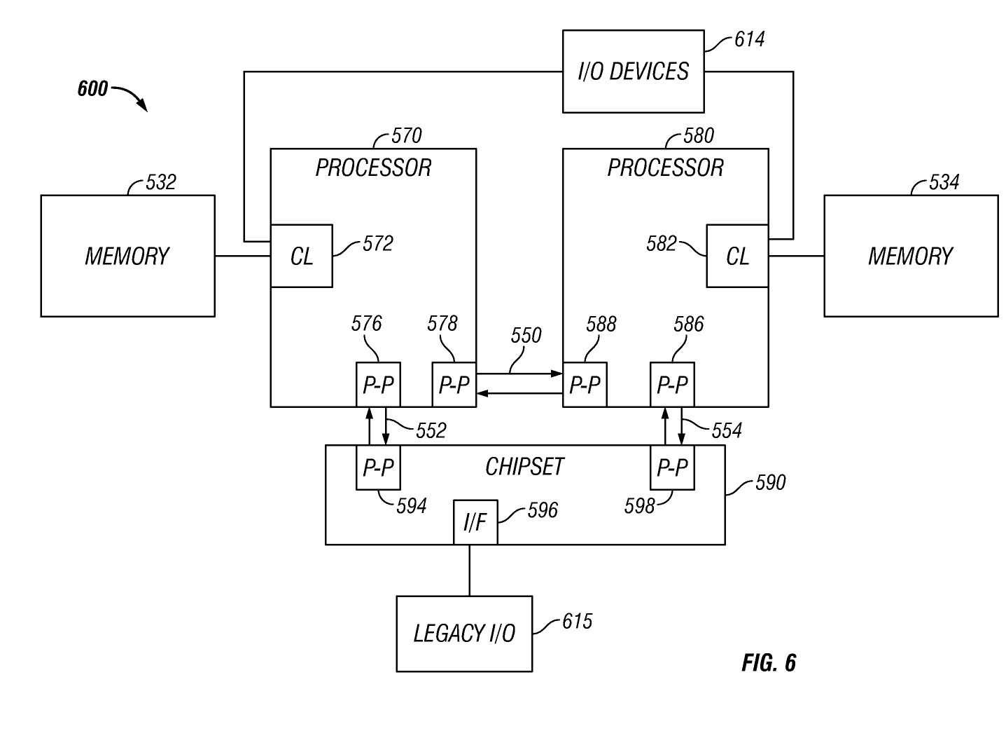

FIG. 6 illustrates a block diagram of a third system 600 in accordance with embodiments of the present disclosure. Like elements in FIGS. 5 and 6 bear like reference numerals, and certain aspects of FIG. 5 have been omitted from FIG. 6 in order to avoid obscuring other aspects of FIG. 6.

FIG. 6 illustrates that processors 670, 680 may include integrated memory and I/O Control Logic (“CL”) 672 and 682, respectively. For at least one embodiment, CL 672, 682 may include integrated memory controller units such as that described above in connection with FIGS. 3-5. In addition. CL 672, 682 may also include I/O control logic. FIG. 6 illustrates that not only memories 632, 634 may be coupled to CL 672, 682, but also that I/O devices 614 may also be coupled to control logic 672, 682. Legacy I/O devices 615 may be coupled to chipset 690.

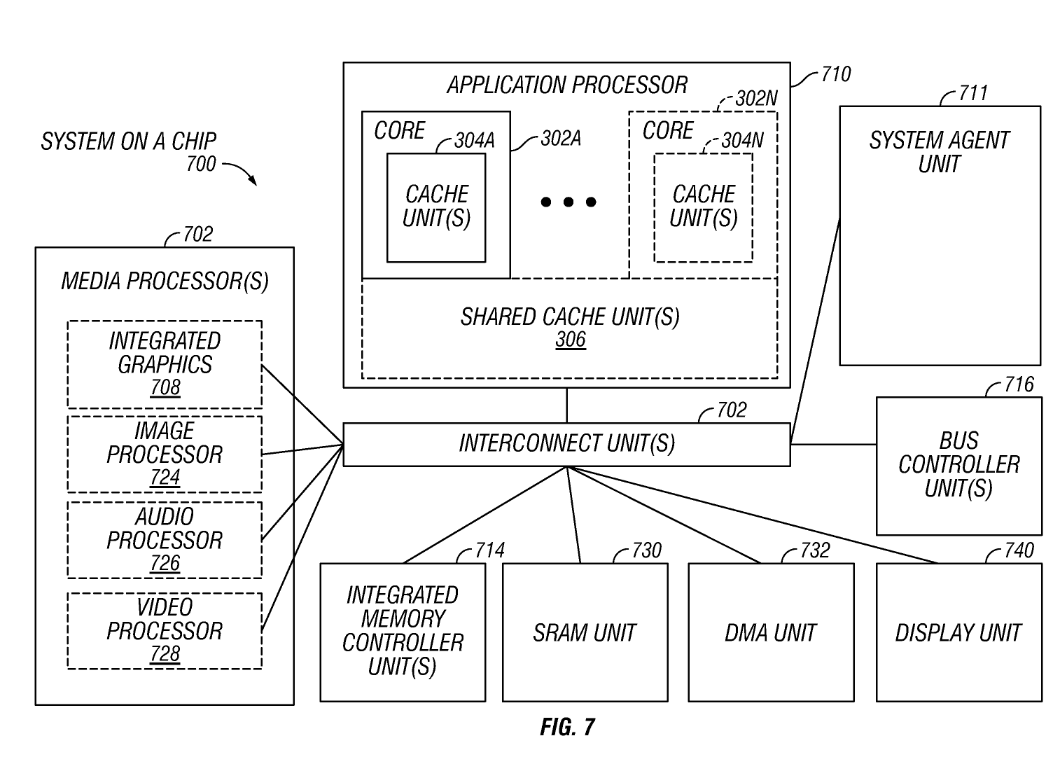

FIG. 7 illustrates a block diagram of a SoC 700, in accordance with embodiments of the present disclosure. Similar elements in FIG. 3 bear like reference numerals. Also, dashed lined boxes may represent optional features on more advanced SoCs. An interconnect units 702 may be coupled to: an application processor 710 which may include a set of one or more cores 702A-N and shared cache units 706; a system agent unit 711; a bus controller units 716; an integrated memory controller units 714; a set or one or more media processors 720 which may include integrated graphics logic 708, an image processor 724 for providing still and/or video camera functionality, an audio processor 726 for providing hardware audio acceleration, and a video processor 728 for providing video encode/decode acceleration; an SRAM unit 730; a DMA unit 732; and a display unit 740 for coupling to one or more external displays.

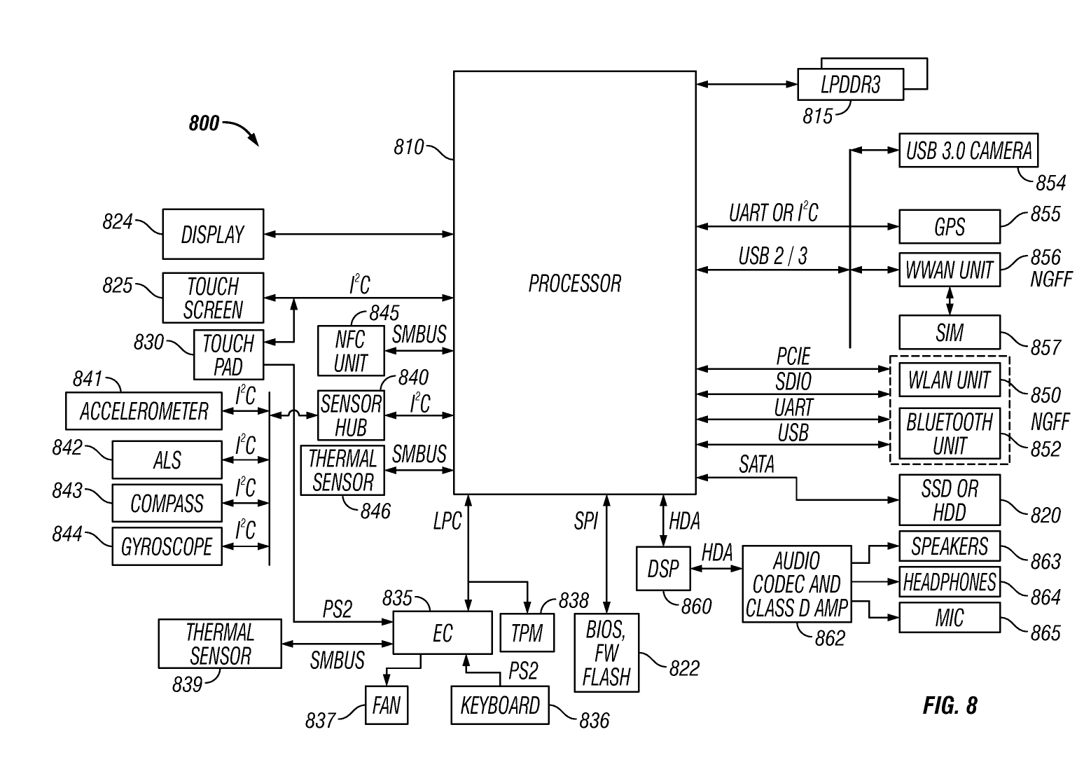

FIG. 8 is a block diagram of an electronic device 800 for utilizing a processor 810, in accordance with embodiments of the present disclosure. Electronic device 800 may include, for example, a notebook, an ultrabook, a computer, a tower server, a rack server, a blade server, a laptop, a desktop, a tablet, a mobile device, a phone, an embedded computer, or any other suitable electronic device.

Electronic device 800 may include processor 810 communicatively coupled to any suitable number or kind of components, peripherals, modules, or devices. Such coupling may be accomplished by any suitable kind of bus or interface, such as I²C bus, System Management Bus (SMBus), Low Pin Count (LPC) bus, SPI, High Definition Audio (HDA) bus, Serial Advance Technology Attachment (SATA) bus, USB bus (versions 1, 2, 3), or Universal Asynchronous Receiver/Transmitter (UART) bus.

Such components may include, for example, a display 824, a touch screen 825, a touch pad 830, a Near Field Communications (NFC) unit 845, a sensor hub 840, a thermal sensor 846, an Express Chipset (EC) 835, a Trusted Platform Module (TPM) 838, BIOS/firmware/flash memory 822, a DSP 860, a drive 820 such as a Solid State Disk (SSD) or a Hard Disk Drive (HDD), a wireless local area network (WLAN) unit 850, a Bluetooth unit 852, a Wireless Wide Area Network (WWAN) unit 856, a Global Positioning System (GPS), a camera 854 such as a USB 3.0 camera, or a Low Power Double Data Rate (LPDDR) memory unit 815 implemented in, for example, the LPDDR3 standard. These components may each be implemented in any suitable manner.

Furthermore, in various embodiments other components may be communicatively coupled to processor 810 through the components discussed above. For example, an accelerometer 841, Ambient Light Sensor (ALS) 842, compass 843, and gyroscope 844 may be communicatively coupled to sensor hub 840. A thermal sensor 839, fan 837, keyboard 846, and touch pad 830 may be communicatively coupled to EC 835. Speaker 863, headphones 864, and a microphone 865 may be communicatively coupled to an audio unit 864, which may in turn be communicatively coupled to DSP 860. Audio unit 864 may include, for example, an audio codec and a class D amplifier. A SIM card 857 may be communicatively coupled to WWAN unit 856. Components such as WLAN unit 850 and Bluetooth unit 852, as well as WWAN unit 856 may be implemented in a Next Generation Form Factor (NGFF).

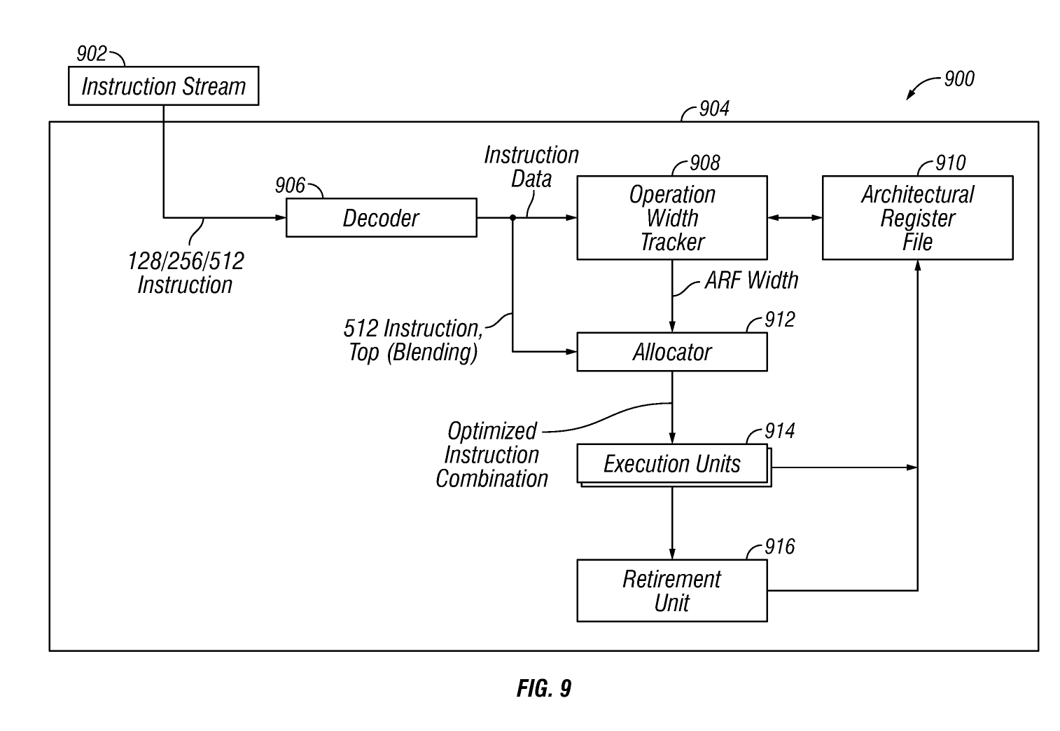

Embodiments of the present disclosure involve an instruction and logic for implementing execution of instructions of multiple widths, including different instruction sets in an instruction set architecture. FIG. 9 illustrates an example system 900 for implementing execution of instructions of multiple widths, in accordance with embodiments of the present disclosure. Various instruction sets may include instructions with a defined bit width, such as 128 bits, 256 bits, or 512 bits. The width of an instruction set may be related to the instruction set architecture of a given processor, such as a processor 904. As processor development progresses, newer processors may be able to execute instruction sets of greater and greater widths. However, existing software may include previously used instruction sets of smaller widths. Accordingly, system 900 may be able to execute instructions form instruction sets with varying widths. These may be present in, for example, instruction stream 902.

The width of an instruction from a given instruction set may be specified according to a maximum number of bits that may be addressed by any given instruction within the instruction set. Such a maximum number of bits may be set according to the number of bits addressable by an intended processor, such as processor 904. For example, processor 904, or a virtual machine therein, may be able to execute instructions that are up 512 bits. Thus, an instruction set including at least some instructions that may address all 512 bits of processor 904 may be referred to as a 512-bit instruction set. However, the same 512-bit instruction set may include instructions that are only performed on a subset of such bits. For example, the 512-bit instruction set may include instructions that only perform operations on 256 bits, 128 bits, 64 bits, or 32 bits. The operation size of such instructions may include 256 bits, 128 bits, 64 bits, or 32 bits, respectively. Nevertheless, such instructions might still be considered members of the 512-bit instruction set, as they are specified within the context of the possibility of executing with respect to all 512 bits. The purpose for including instructions with operation sizes less than the width of instruction set may include, for example, compatibility with older code. Two instructions with differing operation sizes (such as with 512 bits and 64 bits, respectively) from the same instruction set and thus having the same instruction width may be compatible. The instruction set may define operations between instructions of differing operation size, or of application of an instruction with a smaller operation size to a destination of full width. The interoperation between these may be handled automatically by the definition of the respective functions within the same instruction set. However, system 900 may implement execution of instructions of multiple widths, wherein, for example, some of instruction stream 902 include instructions from both a 128-bit width instruction set and a 512-bit width instruction set.

Instruction stream 902 may include instructions from, for example, software, a script, an executable, a library, software-as-a-service, another system, or another processor that are to be executed by processor 904. Instruction stream 902 may include, for example, instructions with widths of 128 bits, 256 bits, and 512 bits, or any combination thereof. Such instructions may include single-instruction, multiple data instructions. In one embodiment, the instructions with a width of 128 bits may include streaming single instruction, multiple data extensions (SSE). In another embodiment, the instructions with a width of 256 bits may include advanced vector extensions (AVX) and AVX2 instructions. In yet another embodiment, the instructions with a width of 512 bits may include AVX512 instructions.

Processor 904 may be able to handle 512-bit instructions, such as AVX512 instructions. However, instruction stream 902 may include 512-bit instructions in addition to 256-bit instructions and 128-bit instructions. In one embodiment, processor 904 may execute instructions of different sizes by assuming that upper, extended parts of its registers are unknown to instructions with a smaller width. For example, processor 904 may execute 128-bit instructions by assuming that the 128-bit instructions do not consider any bits from 129 to 512. Implementing differently sized instructions may present challenges for efficiency, as applying 128-bit instructions and 256-bit instructions within processor 904 may require extra processing to ensure that such instructions are processed correctly and the results are stored correctly. For example, a 128-bit instruction may be included within instruction stream 902 and, as it is executed in processor 904, it may be as applied to a register with a full width of processor 904, such as register of 512 bits. The additional bits of the register, whether as an operand or as a destination, as unused by the 128-bit instruction may need to be considered when executing the instruction and storing the results. Taking account of such bit-size mismatches may be considered by adding a blending operation, and the necessary blending operation may depend upon the specific operations, bit sizes, and registers involved.

A blending operation may be implemented as a blending instruction. The blending operation may be applied to a destination or operand of a pending instruction, wherein the blending operation causes the destination or operand to be effectively compatible with the pending instruction. In one embodiment, a blending operation or blending instruction may be unnecessary, as the mismatch in instructions might not result in any potential problems. In another embodiment, a blending operation or blending instruction may include masking values above the range of bits of the pending instruction. In yet another embodiment, a blending operation or blending instruction may include setting bits to zero that are above the range of bits of the pending instruction.

In one embodiment, all instructions smaller than the full instruction width capability of processor 904, such as 128-bit and 256-bit instructions, may be blended so as to provide compatibility with the 512-bit registers in processor 904. However, addition of blending instructions within each such instruction may be inefficient, as execution of the blending instruction incurs a power and performance penalty. In another embodiment, blending instructions may be dynamically and selectively applied to instructions smaller than the full instruction width capability of processor 904. In such an embodiment, processor 904 may selectively remove blending instructions. Processor 904 may include any suitable mechanisms for dynamically and selectively applying blending instructions. Processor 904 may be implemented in part by the elements of FIGS. 1-8.

Processor 904 may include a decoder 906, allocator 912, execution units 914, and retirement unit 916. In one embodiment, processor 904 may include an operation width tracker 908. In another embodiment, processor 904 may include an architectural register file 910.

Decoder 906 may be implemented in part by decoder 144, decoder 165, or decoder 228, discussed above. Decoder 906 may decode instructions received by processor 904, such as those in instruction stream 903. Decoder 906 may pass decoded instruction in the form of uops or microinstructions to, for example operation width tracker 908 and allocator 912.

Allocator 912 may be implemented in part by out-of-order engine 203. Allocator 912 may allocate buffers and resources that each uop needs in order to execute. Although not illustrated, other portions of an execution engine, such as register renaming logic or schedulers, may be used by processor 904. Allocator 912 may pass instructions for execution on to execution units 914.

Execution units 914 may be implemented fully or in part by execution units 108, 142, 162, 212, 214, 216, 218, 220, 222, 224, discussed above. Execution units 914 may be included in one or more cores. Execution units 914 may execute instructions as decoded and allocated by processor 904. After execution, results of execution may be stored in registers, caches, memory. Furthermore, retirement unit 916 may commit the results of execution to such registers, caches, or memory, provided that the respective instruction may be safely retired.

In one embodiment, processor 904 may decode all instructions with the presumption that they will be blended, while selectively removing blending instructions when they are not needed. Such selective removal of blending instructions may be performed later in the execution pipeline after decoding. In another embodiment, such selective removal of blending instructions may be performed by allocator 912. In yet another embodiment, allocator 912 may utilize information operation width tracker 908 about the state of various registers or other processor components to determine whether to selectively remove blending instructions associated with a given instruction. Moreover, allocator 912 may utilize information about the instruction as decoded by decoder 906 to selectively remove blending instructions.

In order to implement selective removal of blending instructions, in one embodiment decoder 906 may decode an instruction from instruction stream 902 into uops as-if blending will be required. Decoder 906 may add a uop specifically for blending the instruction from instruction stream 902 during execution by processor 904. In a further embodiment, decoder 906 may decode smaller-width instructions into uops as-if blending will be required. For example, decoder 906 may decode 128-bit and 256-bit instructions into uops as-if they will be blended for execution within a 512-bit execution unit. The resulting 512-bit instruction, including a uop for blending operation, may be sent to allocator 912 and operation width tracker 908, along with any other information useful for the operation of allocator 912 and operation width tracker 908. Allocator 912 may later selectively remove any uops for blending operations wherein the blending operation has been determined to be unnecessary.

Operation width tracker 908 may be implemented in any suitable manner, such as with logic, analog circuitry, or digital circuitry. Operation width tracker 908 may track the width of contents in various registers or other components of processor 904 as instructions are executed and results are stored in, for example, the various registers. Operation width tracker 908 may provide, for a given instruction received from decoder 906, a state reflecting the effective width of data of an associated register. Such a state, indicating the effective width of the associated register, may be provided to allocator 912.

For example, if a 128-bit load operation designates a given register as a destination, then operation width tracker 908 may track that the given register has been used with, at most, a 128-bit instruction. In another example, if a 128-bit add operation is made to a given register which previously stored the results of a 256-bit operation, then operation width tracker 908 may track that the given register has been used with a 256-bit operation. In yet another example, if an operation is made to a given register which previously stored the results of a 512-bit operation, then operation width tracker 908 may track that the given register has been used with a 512-bit operation. Such a state may change as new values are loaded in given registers or other operations performed. The state may illustrate an effective width, wherein even though the register may be capable of handling value up to, for example, 512 bits, only a subset (such as 128 bits or 256 bits) have been used in previous operations.

In one embodiment, operation width tracker 908 may reflect the status of registers represented in architectural register file 910. Moreover, operation width tracker 908 may separately track the various registers represented in architectural register file 910. Thus, a state may be specified for each register.

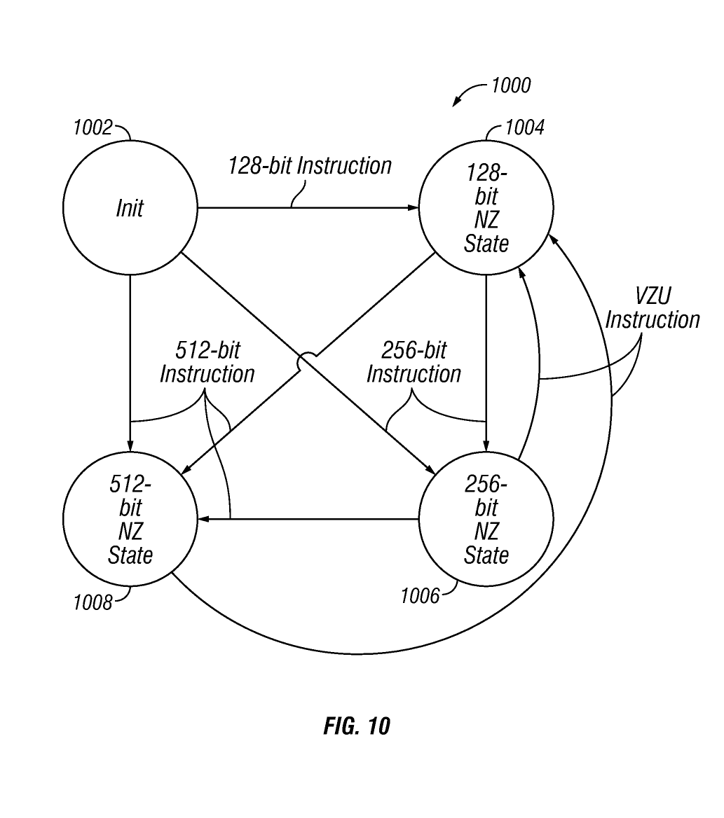

FIG. 10 is a more detailed illustration of an operation width tracker 1000 in accordance with embodiments of the present disclosure. Operation width tracker 1000 may implement, fully or in-part, operation width tracker 908 of FIG. 9. The functionality of operation width tracker 1000 is illustrated as a state machine, including four states 1002, 1004, 1006, 1008. The state machine illustrating operation width tracker 1000 shows that operations of various sizes, such as 128-bit, 256-bit, and 512-bit instructions, may be intermixed while the state of a register, upon which such instructions are applied, may be tracked.

Initially, a processor state with respect to the register is an initial state indicated by state 1002. For the associated contents of architectural register file 910, state 1002 may indicate that all bits are known to be zero.

Upon the subsequent operation of a 128-bit instruction, 256-bit instruction, or 512-bit instruction, operation width tracker 1000 may determine that architectural register file 910 is considered to be non-zero in its lower bits. The number of lower bits for which the architectural register file 910 is considered to be non-zero may depend upon the width of the instruction. Thus, if the instruction is a 128-bit instruction, then architectural register file 910 may be considered non-zero for its lowest 128 bits, but zero for all other bits. The state of operation width tracker 1000 may move to state 1004. If the instruction is a 256-bit instruction, then architectural register file 910 may be considered non-zero for its lowest 256 bits, but zero for all other bits. The state of operation width tracker 1000 may move to state 1006. If the instruction is a 512-bit instruction, then architectural register file 910 may be considered non-zero for its lowest 512 bits. The state of operation width tracker 1000 may move to state 1008. The resulting state may be reported to allocator 912.

Upon a subsequent operation of a 128-bit instruction, if operation width tracker 1000 is in state 1004, then operation width tracker 1000 may remain in state 1004. Furthermore, upon a subsequent operation of a 128-bit instruction, if operation width tracker 1000 is in state 1006, then operation width tracker 1000 may remain in state 1006. In addition, upon a subsequent operation of a 128-bit instruction, if operation width tracker 1000 is in state 1008, then operation width tracker 1000 may remain in state 1008. The resulting state may be reported to allocator 912.

Upon a subsequent operation of a 256-bit instruction, if operation width tracker 1000 is in state 1004, then operation width tracker 1000 may move to state 1006. Furthermore, upon a subsequent operation of a 256-bit instruction, if operation width tracker 1000 is in state 1006, then operation width tracker 1000 may remain in state 1006. In addition, upon a subsequent operation of a 256-bit instruction, if operation width tracker 1000 is in state 1008, then operation width tracker 1000 may remain in state 1008. The resulting state may be reported to allocator 912.

Upon a subsequent operation of a 512-bit instruction, if operation width tracker 1000 is in state 1004, then operation width tracker 1000 may move to state 1008. Furthermore, upon a subsequent operation of a 512-bit instruction, if operation width tracker 1000 is in state 1006, then operation width tracker 1000 may move to state 1008. In addition, upon a subsequent operation of a 512-bit instruction, if operation width tracker 1000 is in state 1008, then operation width tracker 1000 may remain in state 1008. The resulting state may be reported to allocator 912.

In one embodiment, operation width tracker 1000 may return to a lower state (1004, 1006) from a higher state (1006, 1008) when it may be assumed that the upper bits represented by the higher state have been zeroed out. For example, following a VzeroUpper operation, which may zero-out all upper bits except the lowest 128 bits, operation width tracker 1000 may return to state 1004. Furthermore, following an operation zeroing out the upper 256 bits, operation width tracker 1000 may return to state 1006 from state 1008.

For example, a 128-bit load operation, performed when operation width tracker 1000 is in state 1002. Accordingly, operation width tracker 1000 may move to state 1004 and report state 1004 to allocator 912. Upon a subsequent 256-bit operation, operation width tracker 1000 may move to state 1006 and report state 1006 to allocator 912. Upon a subsequent 128-bit operation, wherein a VzeroUpper operation (or another operation clearing bits 129-256) has not executed in the meantime, operation width tracker 1000 may remain in state 1006 and report state 1006 to allocator 912. Upon a subsequent VzeroUpper operation (or another operation clearing bits 129-256), operation width tracker 1000 may move to state 1004 and report state 1004 to allocator 912. Upon yet another subsequent 128-bit operation, operation width tracker 1000 may remain in state 1004 and report state 1004 to allocator 912.

Returning to FIG. 9, allocator 912 may interpret the information received from operation width tracker 908 to determine whether blending is required or not. In one embodiment, if the width of the pending instruction from instruction stream 902 matches the state reported by operation width tracker 908, then no blending may be necessary. A blend instruction, as inserted by decoder 906 or otherwise determined, may be discarded or otherwise not used. In another embodiment, if the width of the pending instruction from instruction stream 902 is less than the state reported by operation width tracker 908, then blending may be necessary. A blend instruction, as inserted by decoder 906 or otherwise determined, may be utilized. For example, if allocator 912 receives an instruction that arrived as a 128-bit operation and operation width tracker 908 indicates that the associated portions of architectural register file 910 are in a 128-bit state, then the instruction may be executed without using a blending instruction. Furthermore, if allocator 912 receives an instruction that arrived as a 128-bit operation and operation width tracker 908 indicates that the associated portions of architectural register file 910 are in a 256-bit state, then the instruction may be executed with a blending instruction. In various embodiments, instructions with a previous instruction set architecture will behave in such a manner. For example, streaming SIMD (SSE) instructions may behave in such a manner. In other embodiments, instructions with updated instruction set architecture might not require blending for 128-bit operations wherein the upper (128-bits/384-bits) are cleared. For example, AVX and AVX512 might not require blending because the upper bits are already cleared.

Table 1 illustrates various blend schemes that may be employed by allocator 912 given various inputs from decoder 906 and operation width tracker 908 and a load operation.

TABLE 1

| Pending | | | Oper- | | | |
|---|---|---|---|---|---|---|
| Instruc- | | | ation | Zero or | Zero or | |
| tion | | | width | blend bits | blend bits | Blend load |
| width | Op-size | Mask? | tracker | 511:256? | 255:128? | operation? |
| 512 | 512 | yes | Any | | | Blend |
| | | | | | | src-dest |
| 512 | 512 | no | Any | | | Disregard |
| | | | | | | blend |
| 512 | 64/32 | yes | Any | z | z | Blend |
| | | | | | | src-dest |
| 512 | 64/32 | no | Any | z | z | Disregard |
| | | | | | | blend |
| 512 | 256 | | Any | z | | Disregard |
| | | | | | | blend |
| 512 | 128/64/ | | Any | z | z | Disregard |
| | 32 | | | | | blend |
| 256 | 256 | | 512nz | b | | Blend |
| | | | | | | src-dest |
| 256 | 128/64/ | | 512nz | b | z | Blend |
| | 32 | | | | | src-dest |
| 256 | 256 | | 256nz | z | | Disregard |
| | | | | | | blend |
| 256 | 128/64/ | | 256nz | z | z | Disregard |
| | 32 | | | | | blend |
| 128 | 128/64/ | | 512nz | b | b | Blend |
| | 32 | | | | | src-dest |
| 128 | 128/64/ | | 256nz | z | b | Blend |
| | 32 | | | | | src-dest |
| 128 | 128/64/ | | 128nz | z | z | Disregard |
| | 32 | | | | | blend |

Table 1 includes three types of columns, including input, state and operation columns. Pending instruction width may be related to the generation of the instruction set architecture, such as 128-bits for SSE, 256-bits for AVX/AVX2 or 512-bits for AVX3. This indication of bits may include the maximal register size defined/allowed by the respective instruction set architecture. As discussed above, an instruction set with instructions of a certain width may nevertheless include instructions with smaller operation sizes, wherein the instructions may address less than the full range of bits. For example, in Table 1, a pending instruction from instruction stream 902 may include instructions with operation sizes of 32, 64, 128, 256, or 512 bits. Those operation sizes less than the 512-bit width of the instruction set may be compatible, as defined within the 512-bit instruction set, with each other and with the 512-bit operation size instruction. However, by selectively blending, system 900 may implement the ability to execute instructions taken from different instruction sets, such as pending instructions with a width of 256 bits and those with a width of 512 bits. The selective blending may be used even if the operation sizes of the respective instructions (taken from different instruction set generations) are the same.

For example, an instruction set corresponding to 512 bits may include individual instructions with operation sizes of 32, 64, 128, 256, or 512 bits. These are illustrated in the first six rows of Table 1. In another example, an instruction set corresponding to 256 bits may include individual instructions with operation sizes of 32, 64, 128, or 256 bits. These are illustrated in the next four rows of Table 1. In yet another example, an instruction set corresponding to 128 bits may include individual instructions with operation sizes of 32, 64, or 128. These are illustrated in the last three rows of Table 1.

Accordingly, in one embodiment Table 1 illustrates, given a pending instruction of a defined width and an operation size of the specific instruction, what blending operations are to be taken. Furthermore, some instructions may include masking to be performed. Accordingly, in another embodiment, Table 1 illustrates, given a pending instruction of a defined width and whether masking is enabled, what blending operations are to be taken. In addition, Table 1 includes a column to indicate a width returned from operation width tracker 908. Accordingly, in yet another embodiment, Table 1 illustrates, given a pending instruction of a defined width and a width returned from operation width tracker 908, what blending operations are to be taken.

In one embodiment, Table 1 may specify whether the highest 256 bits (from bit position 511 down to 256, assuming the first bit is indexed at zero) are zeroed or blended. In another embodiment, Table 1 may specify whether the next 128 bits (from bit position 255 down to 128) are zeroed or blended. In yet another embodiment, Table 1 may specify whether the load operation should be blended, or whether the blend may be disregarded.

For example, given a pending instruction with a 512-bit width, an operation size of 512 bits, a 512-bit state from operation width tracker 908, but where masking is employed, blending may be used to accommodate the masking. None of the highest 256 bits or next 128 bits might need blending or zeroes, except for those specified within the mask. In another example, given a pending instruction with a 512-bit width, an operation size of 512 bits, a 512-bit state from operation width tracker 908, and where masking is not employed, no blending might be needed, as a 512-bit wide instruction is to be executed within a 512-bit context. Furthermore, the same results may occur even if the operation size of the instruction is 32, 64, 128, 256, or 512 bits. If the operation size of the pending instruction is 32, 64, or 128 bits, then the bits from position 511 to 128 may be zeroed. If the operation size of the pending instruction is 256 bits, then the bits from position 511 to 256 may be zeroed.

In another example, given a pending instruction with a 256-bit width and a 512-bit state from operation width tracker 908, blending may be used. However, given a pending instruction with a 256-bit width and a 256-bit state, no blending might be needed. Furthermore, the same results may occur even if the operation size of the instruction is 32, 64, 128, or 256 bits, since the result is zeroed till the upper allowed width. If the pending instruction has a 256-bit width, a 256-bit operation size, and the state is 512 bits, then bits from position 511 to 256 may be blended. If the pending instruction has a 256-bit width, a 128-bit operation size (or smaller), and the state is 512 bits, then bits from position 511 to 256 may be blended and bits from position 255 to 128 may be zeroed.

In yet another example, given a pending instruction with a 128-bit width and a 512-bit state from operation width tracker 908, blending may be used. Given a pending instruction with a 128-bit width and a 256-bit state from operation width tracker 908, blending may be used. However, given a pending instruction with a 128-bit width and a 128-bit state, no blending might be needed. Furthermore, the same results may occur even if the operation size of the instruction is 32, 64, or 128 bits. If the state from operation width tracker 908 is 512 bits, then the bits from position 511 to 128 may be blended. If the state from operation width tracker 908 is 256 bits, then the bits from position 511 to 256 may be zeroed and the bits from position 255 to 128 may be blended. If the state from operation width tracker 908 is 128 bits, then the bits from position 511 to 128 may be zeroed.

In various embodiments, zeroing out values may be performed with functions that may be tracked by operation width tracker 908. Such functions may include, for example, clearing the destination register till the max allowed width value.

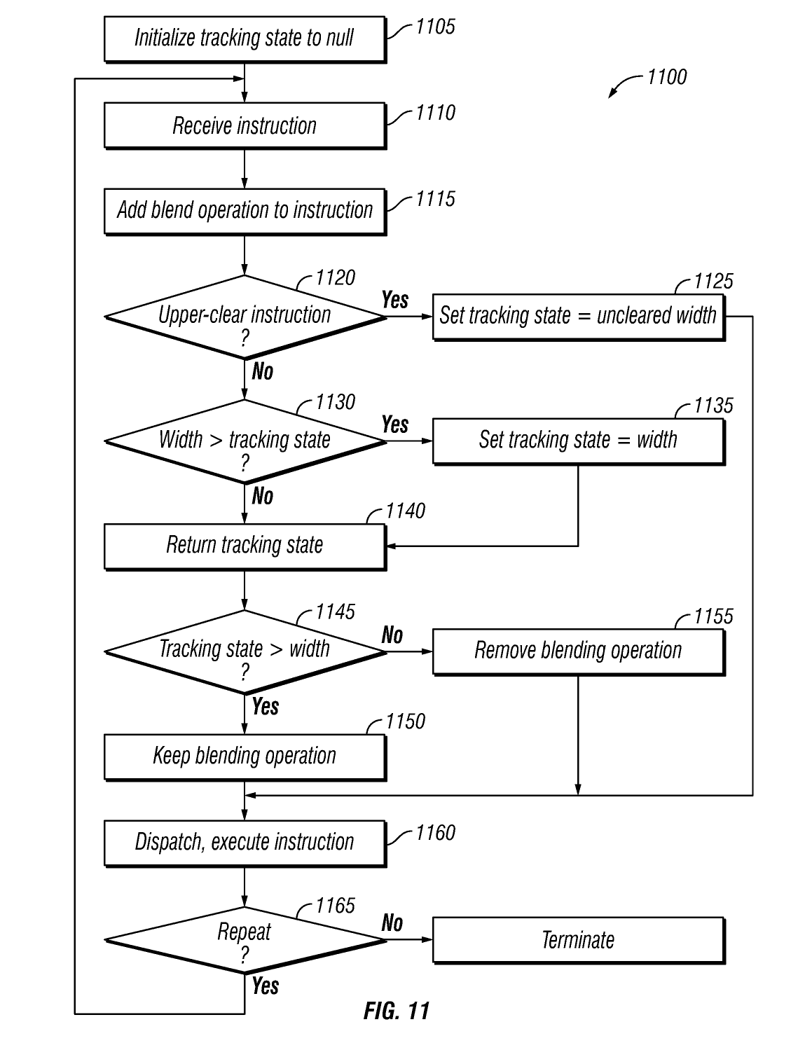

FIG. 11 is a flowchart of an example embodiment of a method 1100 for implementing execution of instructions of multiple widths, in accordance with embodiments of the present disclosure. Method 1100 may illustrate operations performed by, for example, processor 904, decoder 906, operation width tracker 908, or allocator 912. Method 1300 may begin at any suitable point and may execute in any suitable order. In one embodiment, method 1100 may begin at 1105.

At 1105, a state machine for tracking a current state of registers, such as those included in architectural register file 910, may be initialized to a null or initial state.

At 1110, an instruction to be executed on a processor may be received. The instruction may be included in one of a plurality of instruction sets, wherein the instruction sets vary according to instruction width. Moreover, each instruction set may include instructions of multiple operation sizes, though each is of the same instruction set width.

At 1115, a blend operation or instruction may be added to the pending instruction. In one embodiment, the blend operation or instruction may instead be optionally added at a later time, such as in conjunction with 1150 and 1155.

At 1120, it may be determined whether the instruction indicates that upper portions of the registers, such as the top 256 bits or top 384 bits, are to be cleared. In response to such an instruction, at 1125 the tracking state of the state machine may be set to the width of instructions that remain. Method 1100 may proceed to 1160. Otherwise, method 1100 may proceed to 1130.

At 1130, it may be determined whether the width of the pending instruction is greater than the tracking state. For example, the pending instruction may be 512 bits and the tracking state may be 256 or 128 bits, in which case method 1100 may proceed to 1135. Otherwise, method 1100 may proceed to 1140 in cases where, for example, the pending instruction and the tracking state are both 512, 256, or 128 bits. At 1135, the tracking state may be set to the larger width of the pending instruction. At 1140, the tracking state may be returned for subsequent use.

At 1145, it may be determined whether the current tracking state is greater than the width of the pending instruction. For example, the current tracking state may be 512 bits and the width of the pending instruction may be 256 or 128 bits. If the current tracking state is greater than the width of the pending instruction, method 1100 may proceed to 1150. Otherwise, method 1100 may proceed to 1155.

At 1150, a blending operation previously added to the pending instruction may be kept. If no such blending operation were previously added, a blending operation may be presently added. The specific blending operation may be made according to, for example Table 1.

At 1155, a blending operation may be removed from the pending instruction.

At 1160, the instruction may be dispatched and executed. At 1165, it may be determined whether to repeat. If so, method 1100 may return to 1110. Otherwise, method 1100 may terminate.

Method 1100 may be initiated by any suitable criteria. Furthermore, although method 1100 describes an operation of particular elements, method 1100 may be performed by any suitable combination or type of elements. For example, method 1100 may be implemented by the elements illustrated in FIGS. 1-11 or any other system operable to implement method 1100. As such, the preferred initialization point for method 1300 and the order of the elements comprising method 1100 may depend on the implementation chosen. In some embodiments, some elements may be optionally omitted, reorganized, repeated, or combined. Furthermore, method 1100 may be performed fully or in part in parallel with each other.

Embodiments of the mechanisms disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code may be applied to input instructions to perform the functions described herein and generate output information. The output information may be applied to one or more output devices, in known fashion. For purposes of this application, a processing system may include any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine-readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the disclosure may also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part-on and part-off processor.

Thus, techniques for performing one or more instructions according to at least one embodiment are disclosed. While certain exemplary embodiments have been described and shown in the accompanying drawings, it is to be understood that such embodiments are merely illustrative of and not restrictive on other embodiments, and that such embodiments not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor, comprising:
an execution unit;
a decoder including a first logic to decode an instruction;
an operation width tracker including a second logic to track a state indicating a currently used width of one or more registers of the processor; and
an allocator including a third logic to selectively blend the instruction with a higher number of bits based upon a width of the instruction and the state.

2. The processor of claim 1, wherein the allocator further includes:
a fourth logic to blend the instruction with a higher number of bits, resulting in a blended instruction, based on a determination that the width of the instruction is less than the currently used width of the one or more registers of the processor indicated by the state; and
a fifth logic to send the blended instruction to the execution unit.

3. The processor of claim 1, wherein:
the decoder includes a fourth logic to include a blend operation with the instruction; and
the allocator includes a fourth logic to keep the blend operation based upon the width of the instruction being less than the currently used width of the one or more registers of the processor indicated by the state.

4. The processor of claim 1, wherein:
the decoder includes a fourth logic to include a blend operation with the instruction; and
the allocator includes a fourth logic to remove the blend operation based upon the width of the instruction being greater than or equal to the currently used width of the one or more registers of the processor indicated by the state.

5. The processor of claim 1, wherein the operation width tracker includes:
a fourth logic to determine that the width of the instruction is greater than a previous width indicated by the state; and
a fifth logic to set the state to a value indicating the width of the instruction based on a determination that the width of the instruction is greater than a previous width indicated by the state.

6. The processor of claim 1, wherein the operation width tracker includes:
a fourth logic to determine a clearing instruction to clear bits of the currently used width of registers of the processor; and
a fifth logic to set the state to a value indicating a lower width based on a determine a clearing instruction to clear bits of the currently used width of registers of the processor.

7. The processor of claim 1, wherein:
the operation width tracker includes a fourth logic to set the state to indicate y bits based upon receipt of an y-bit instruction from an y-bit instruction set;
the allocator includes a fifth logic to route the y-bit instruction to the execution unit for execution;
the operation width tracker further includes a fifth logic to evaluate an x-bit instruction from an x-bit instruction set subsequent to setting the state to y bits;
the allocator further includes a sixth logic to blend the x-bit instruction with higher-order bits based on a determination that the state indicates y bits, the instruction is x bits wide, and the number of x bits is less than the number of y bits.

8. A system, comprising:
an execution unit;
a decoder including a first logic to decode an instruction;
an operation width tracker including a second logic to track a state indicating a currently used width of one or more registers of the system; and
an allocator including a third logic to selectively blend the instruction with a higher number of bits based upon a width of the instruction and the state.

9. The system of claim 8, wherein the allocator further includes:
a fourth logic to blend the instruction with a higher number of bits, resulting in a blended instruction, based on a determination that the width of the instruction is less than the currently used width of the one or more registers of the system indicated by the state; and
a fifth logic to send the blended instruction to the execution unit.

10. The system of claim 8, wherein:
the decoder includes a fourth logic to include a blend operation with the instruction; and
the allocator includes a fourth logic to keep the blend operation based upon the width of the instruction being less than the currently used width of the one or more registers of the system indicated by the state.

11. The system of claim 8, wherein:
the decoder includes a fourth logic to include a blend operation with the instruction; and
the allocator includes a fourth logic to remove the blend operation based upon the width of the instruction being greater than or equal to the currently used width of the one or more registers of the system indicated by the state.

12. The system of claim 8, wherein the operation width tracker includes:
a fourth logic to determine that the width of the instruction is greater than a previous width indicated by the state; and
a fifth logic to set the state to a value indicating the width of the instruction based on a determination that the width of the instruction is greater than a previous width indicated by the state.

13. The system of claim 8, wherein the operation width tracker includes:
a fourth logic to determine a clearing instruction to clear bits of the currently used width of registers of the system; and
a fifth logic to set the state to a value indicating a lower width based on a determine a clearing instruction to clear bits of the currently used width of registers of the system.

14. The system of claim 8, wherein:
the operation width tracker includes a fourth logic to set the state to indicate y bits based upon receipt of an y-bit instruction from an y-bit instruction set;
the allocator includes a fifth logic to route the y-bit instruction to the execution unit for execution;
the operation width tracker further includes a fifth logic to evaluate an x-bit instruction from an x-bit instruction set subsequent to setting the state to y bits;
the allocator further includes a sixth logic to blend the x-bit instruction with higher-order bits based on a determination that the state indicates y bits, the instruction is x bits wide, and the number of x bits is less than the number of y bits.

15. A method for executing instructions in a processor, comprising:
decoding an instruction;
tracking a state indicating a currently used width of one or more registers of the processor; and
selectively blending the instruction with a higher number of bits based upon a width of the instruction and the state.

16. The method of claim 15, further comprising:
blending the instruction with a higher number of bits, resulting in a blended instruction, based on a determination that the width of the instruction is less than the currently used width of the one or more registers of the processor indicated by the state; and
executing the blended instruction.

17. The method of claim 15, further comprising:
adding a blend operation to the instruction at a decoding stage of the processor; and
keeping the blend operation at an allocation stage of the processor based upon the width of the instruction being less than the currently used width of the one or more registers of the processor indicated by the state.

18. The method of claim 15, further comprising:
adding a blend operation to the instruction at a decoding stage of the processor; and
removing the blend operation at an allocation stage based upon the width of the instruction being greater than or equal to the currently used width of the one or more registers of the processor indicated by the state.

19. The method of claim 15, further comprising:
determining that the width of the instruction is greater than a previous width indicated by the state; and
setting the state to a value indicating the width of the instruction based on a determination that the width of the instruction is greater than a previous width indicated by the state.

20. The method of claim 15, further comprising:
determining a clearing instruction to clear bits of the currently used width of registers of the processor; and
setting the state to a value indicating a lower width based on a determine a clearing instruction to clear bits of the currently used width of registers of the processor.
